(19) United States
(12) Patent Application Publication
(10) Pub. No.: US 2008/0060535 A1
(43) Pub. Date: Mar. 13, 2008

(54) METHOD FOR INLINE DIE CUTTING THAT COMPENSATES FOR IMAGE VARIANCES

(75) Inventors: Paul Andrew Edwards, Ypsilanti, MI (US); John Hennessy, Grosse Pointe Park, MI (US); Frank Bruck, Ypsilanti, MI (US)

Correspondence Address: HARNESS, DICKEY & PIERCE, P.L.C., P.O. BOX 828, BLOOMFIELD HILLS, MI, 48303, US

(73) Assignee: ELECTRONICS FOR IMAGING, INC., FOSTER CITY, CA (US)

(21) Appl. No.: 11/851,900

(22) Filed: Sep. 7, 2007

Related U.S. Application Data
(60) Provisional application No. 60/843,492, filed on Sep. 8, 2006.

(51) Int. Cl. B31F 1/07

(52) U.S. Cl. 101/32

(57) ABSTRACT

A method of inline die cutting of a substrate including providing a substrate having a print image thereon; detecting a position of the print image and outputting a web position signal; computing a die correction signal in response to the web position signal and outputting the die correction signal; and adjusting the position of a die in response to the die correction signal to ensure cutting of the substrate at a predetermined location.

### CROSS-REFERENCE TO RELATED APPLICATIONS

This application claims the benefit of U.S. Provisional Application No. 60/843,492 filed on Sep. 8, 2006.

### FIELD

The present teachings relate to cutting printed materials and, more particularly, relate to inline die cutting that compensates for image variances.

### BACKGROUND

The statements in this section merely provide background information related to the present teachings and may not constitute prior art.

Print methods used today are more precise and accurate than at any time in previous history. However, variances in the printed image size and pitch (spacing between images) still exist and can cause problems in further processing steps such as during rotary die cutting.

Rotary die cutters use cylindrical rollers imbedded with cutting edges shaped as the desired perimeter of the finished product. This perimeter shape is “placed on the round” in the rotary die cutter manufacturing process. A specific cutting tool, or die, is used for each print image, and must match up with the size and pitch of the printed images. Failure to match the cutting die to the print repeat results in unacceptable cutting variances. A small error amount between die and print length can rapidly become a large error as each new spacing error amount adds to (or subtracts from) the previous offset. Thus, over time, this error becomes cumulative and progressively more undesirable.

In the case where the error between die cutter and image shows up in a random pattern, the overall error may not be cumulative, but die cutting accuracy is still compromised from the image to image miss-match. Traditional print methods that use mechanical component (rollers, plates, gears) generally are more repeatable than images printed using digital technology. Images printed with digital technology use electronic print head drivers, software, electronic boards and interconnections to achieve the printed images instead of fixed gears, rollers, and print plates/rollers. This printing method can be referred to as “non-contact”. Variances in the operating speeds/frequencies of the electronics and software in the systems can cause variances in the length of printed images. In all print methods, changes in the pitch of the printed images should be compensated for in downstream processing or finishing.

Previous work to control variances between printing and die cutting have centered on using in line web brakes to “stretch” the printed material to match the die size and repeat. Print plates/rollers and die cutting tools are designed such that the die cutter repeat is slightly longer than the print repeat. The substrate is then retarded slightly during die cutting, creating tension in the substrate and causing the printed image and substrate to stretch. This method works if the print and pitch variances are very small and consistent. However, it will not work if the print and pitch variances are large, inconsistent, or if the printed image pitch is “longer” than the die cutter repeat. If the pitch delta is large, the tension created to stretch the substrate can cause the substrate to tear. If the printed image is “longer” than the die repeat, current systems will not work. The mechanism is only capable of stretching the substrate, not shortening it. In the case of random variance in pitch length, again, with the ability to only “stretch” the substrate, the system will arrive at some average tension and corresponding stretch, and would not be able to accommodate image to image variances for each image, limiting cutting accuracy.

### SUMMARY

According to the principles of the present teachings, methods are provided that enable more accurate die cutting of printed material. The present teachings include providing a substrate having a print image thereon; detecting a position of the print image and outputting a web position signal; computing a die correction signal in response to the web position signal and outputting the die correction signal; and adjusting the position of a die in response to the die correction signal to ensure cutting of the substrate at a predetermined location.

In correcting the position of the cutting die, the system can either retard or accelerate the cutting die. This approach does not place the substrate under extreme tension, or vary the tension of the substrate at all, thus substrate tears are eliminated. For the same reason, it can also handle conditions when the print length or pitch length is longer than the die tooling repeat. The accuracy to which the print and cutting tools are matched in this system can be easily increased. The image and die cutter positions can be checked and compared multiple times per image, further improving cutting accuracy. For these reasons, this method is significantly more tolerant of print length variances that exist in digital and traditional print methods.

Further areas of applicability will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a flow chart according to the principles of the present teachings.

### DETAILED DESCRIPTION

The following description is merely exemplary in nature and is not intended to limit the present teachings, application, or uses.

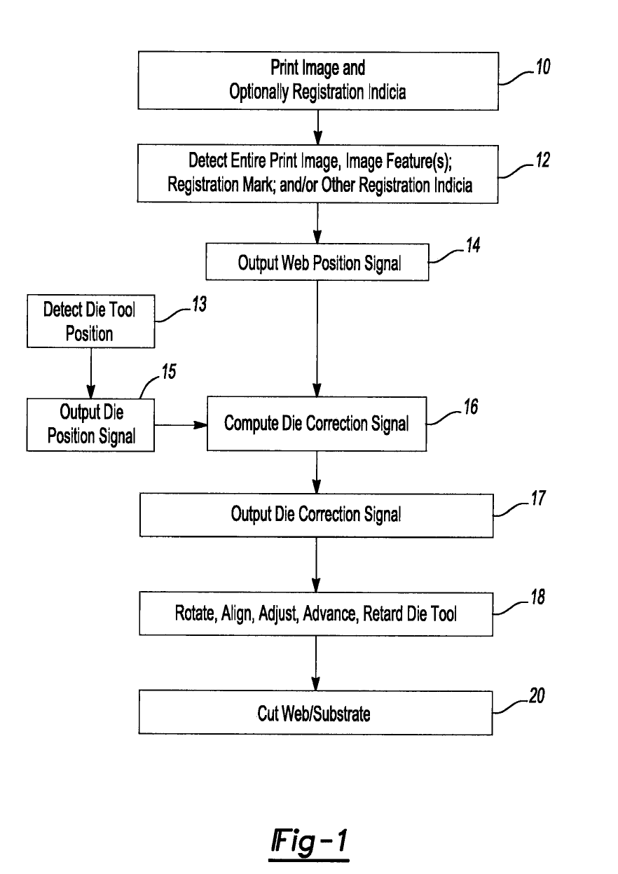

With reference to FIG. 1, the present teachings utilize enhancements to rotary die cutter technology that allow synchronization of a die cutter with a digital ink jet printing press, or other traditional printing press. In rotary die cutting operations, the image repeat to be cut must equal the perimeter (e.g. circumference) of the rotary cutting tool. If these two lengths are not equal, misregistration between the die and the printed image will begin to occur and the degree of error will grow with each rotation of the die. The present teachings incorporate sensors, such as optical sensors, that read the position of the printed substrate and/or the die cutting tooling in real time, during the die cutting process. The positions are compared electronically and, if necessary, the position of the rotary die is changed to compensate for the error in registration as detected by the sensors.

With particular reference to FIG. 1, the method of the present teachings comprises combinations of the following method steps. As referenced at step 10, an image is printed upon a substrate or web. In some embodiment, the printing of the image is completed through non-contact printing, including ink jet printing. The image may include registration features either inherent in the image itself, such as strong contrast sections or lines; registration marks, ticks, or indicia; and/or the like conducive for detection. It should be appreciated that these registration features may be inconspicuously placed on the substrate or web to minimize any distracting effect on the image. It should also be appreciated that the scope of the present teachings are not limited to printing of the image on the substrate or web immediately before the following method steps. Therefore, a plurality of images can be printed on a substrate and later die cut according to the present teachings.

Following step 10, one or more sensors can be used to sense one or more of the registration features indicated herein as indicated in step 12 and output a web position signal as indicated in step 14. The one or more sensors reading the print image on the substrate can be positioned appropriately close to the substrate to reliably detect the image length based on the registration feature.

Additional sensors can be used to sense a position of the die tool as indicated in step 13 and output a die tool signal as indicated in step 15. The die tool signal can be representative of the position of the die tool. The sensors reading the die tool position can read the cutter position by detecting marks, grooves, or any optical feature incorporated into the die tool. However, based on consistent drive information of the die tool and corresponding time information, positioning of the die tool can, in some applications, be sufficiently accurately known to achieve proper and acceptable die cutting tolerance relative to the print image. Therefore, it should be understood that steps 13 and 15 may not be required in all applications.

As referenced in step 16, the web position signal from step 14 and the die tool signal 15 can be used to compute and output a die correction signal as indicated in step 17. This die correction signal can generated using an electronic logic processor (PLC, PC or other electronic controller) that has the ability to compare the positional inputs and provide the die correction signal to a die cutting drive system according to a predetermined algorithm or code.

The die correction signal, as indicated in step 18, can be use by a die cutting drive, which can include a servo, stepper or other motion control system optionally having an integral positional feedback element (high resolution encoder) operably coupled to the die tool, to properly position the die tool to cut the web or substrate to achieve proper alignment relative to the print image. It should also be appreciated that the servo, stepper, or other motion control system can be used to rotate, align, and/or adjust the position of the die tool to achieve this desired cutting alignment. In some embodiments, this is accomplished by the servo motor, which is directly driving the die cylinder. In response to the die correction signal, the servo can instantaneously speed up or slow down to synchronize the die tool again with the print image position.

Finally, as indicated in step 20, the substrate or web is cut by the die tool in accordance with the die correction signal. This die correction signal and adjustment can be made, confirm, and/or adjusted one or more time during each cutting operation to achieve a high degree of accuracy. That is, these small corrections can be made once or several times per revolution, ensuring excellent registration control.

What is claimed is:

1. A method of inline die cutting of a substrate, the method comprising:
providing a substrate having a print image thereon;
detecting a position of the print image and outputting a web position signal;
computing a die correction signal in response to the web position signal and outputting the die correction signal; and
adjusting the position of a die in response to the die correction signal to ensure cutting of the substrate at a predetermined location.

2. The method according to claim 1 wherein the providing a substrate having a print image thereof comprising:
providing a substrate; and
printing the print image upon the substrate through non-contact printing.

3. The method according to claim 2 wherein the printing the print image upon the substrate through non-contact printing comprises printing the print image upon the substrate through non-contact printing using ink jet printing.

4. The method according to claim 1 wherein the providing a substrate having a print image thereof comprising:
providing a substrate; and
printing the print image upon the substrate having registration indicia.

5. The method according to claim 4 wherein the detecting a position of the print image and outputting a web position signal comprises detecting the position of the print image by detecting the registration indicia and outputting the web position signal.

6. The method according to claim 4 wherein the registration indicia comprises at least one of image features of the print image and high contrast portions of the print image.

7. The method according to claim 1, further comprising:
detecting a position of the die and outputting a die position signal; and
wherein the computing the die correction signal in response to the web position signal and outputting the die correction signal comprises computing the die correction signal in response to the web position signal and the die position signal and outputting the die correction signal.

8. The method according to claim 1 wherein the adjusting the position of the die in response to the die correction signal to ensure cutting of the substrate at the predetermined location comprises at least one of rotating, aligning, adjusting, advancing, and retarding the die.

9. A method of inline die cutting of a substrate, the method comprising:
providing a substrate;
printing a print image upon the substrate through non-contact printing;
detecting a position of the print image and outputting a web position signal;
detecting a position of a die and outputting a die position signal;
computing a die correction signal in response to the web position signal and the die position signal and outputting a die correction signal; and
adjusting the position of the die in response to the die correction signal to ensure cutting of the substrate at a predetermined location.

10. The method according to claim 9 wherein the printing the print image upon the substrate through non-contact printing comprises printing the print image upon the substrate through non-contact printing using ink jet printing.

11. The method according to claim 9 wherein the printing the print image upon the substrate through non-contact printing comprises printing the print image having registration indicia upon the substrate through non-contact printing.

12. The method according to claim 11 wherein the detecting a position of the print image and outputting a web position signal comprises detecting the position of the print image by detecting the registration indicia and outputting the web position signal.

13. The method according to claim 11 wherein the registration indicia comprises at least one of image features of the print image and high contrast portions of the print image.

14. The method according to claim 9 wherein the adjusting the position of the die in response to the die correction signal to ensure cutting of the substrate at the predetermined location comprises at least one of rotating, aligning, adjusting, advancing, and retarding the die.
